(19) United States
(12) Patent Application Publication
(10) Pub. No.: US 2001/0031855 A1
(43) Pub. Date: Oct. 18, 2001

(54) Water-soluble polyalkylene glycol oils having a high viscosity index and low aerosol toxicity

(75) Inventors: Klaus Pollmann, Burghausen (DE); Rainer Kupfer, Hattersheim (DE)

Correspondence Address: Clariant Corporation,, Industrial Property Department, 4331 Chesapeake Drive, Charlollte, NC, 28216, US

(73) Assignee: Clariant GmbH

(21) Appl. No.: 09/836,303

(22) Filed: Apr. 17, 2001

(30) Foreign Application Priority Data
Apr. 17, 2000 (DE) 10019178.9
Apr. 27, 2000 (DE) 10020669.7

(51) Int. Cl. C08G 65/34

(52) U.S. Cl. 528/425

(57) ABSTRACT

The invention relates to ethylene oxide/propylene oxide copolymers which are obtainable by copolymerizing ethylene oxide and propylene oxide with an alcohol having 4 to 12 carbon atoms and 4 to 12 OH groups, the copolymer having an ethylene oxide/propylene oxide weight ratio of from 40:60 to 60:40 and a molecular weight of from 2000 to 10000 g/mol, and to their use in lubricant formulations, formulations for fiber preparation and metal machining fluids.

The present invention relates to polyalkylene glycol copolymers which are used as base oils for water-soluble lubricant formulations, and to their use in open systems which tend to form aerosols.

Copolymers with ethylene oxide and propylene oxide as starting monomers have been used for many years as base oils for the preparation of high-performance lubricants whose major areas of application are the production of metal machining fluids and lubricants in fiber processing.

This group of products is synthetically obtainable by anionic polymerization of ethylene oxide together with propylene oxide, starting from a mono- or difunctional alcoholate.

The major advantages of these polyglycol copolymers as lubricants are their high viscosity index (i.e. low temperature dependence of the viscosity), low coefficients of friction even without the addition of friction/antiwear additives, controlled establishment of the degree of water solubility of the copolymer through the choice of the ethylene oxide/propylene oxide ratio (characterized by high turbidity points) and very low pour points. Linear copolymers having a weight ratio of ethylene oxide to propylene oxide monomers in the range from 40:60 to 60:40 have proven particularly advantageous. These copolymers have, on the one hand, very low pour points of less than −30° C., good water solubility (turbidity points greater than 50° C.) and very high viscosity indexes (greater than 250).

Recently, however, toxicological studies of aerosols of this class of substances have shown that these products are potentially very hazardous to health. (Literature: ECETOC, European Centre for Ecotoxicology and Toxicology of Chemicals, Technical Report No. 55, March 1997). Thus, for example, monobutoxyethylene oxide/propylene oxide copolymers which contain ethylene oxide and propylene oxide in a weight ratio of 50:50 exhibited, at a molecular weight of about 4000 g/mol, very high aerosol toxicity characterized by a low LC₅₀ value of only 106 mg/m³. Furthermore, pure ethylene oxide/propylene oxide copolymers which contain ethylene oxide and propylene oxide in a weight ratio of 50:50 and have a molecular weight of 4000 g/mol showed LC₅₀ values of about 300 mg/M³ (D. B. Warheit, Inhalation Toxicol. (1995), 7 (3) 377-92). This high toxicity of the aerosol made it necessary for processors and users of these linear copolymers to take complicated technical measures, such as, for example, encapsulation of the plants, for protecting the personnel from aerosols.

It was accordingly the object of the present invention to prepare base oils for lubricants, which oils have just as good water solubility and similarly high viscosity indexes and low coefficients of friction as the ethylene oxide/propylene oxide copolymers obtainable from mono- or difunctional alcoholates and which have very low pour points. However, these base oils should have no toxicological potential on aerosol formation and should thus dispense with complicated protective measures during handling.

Surprisingly, it was found that polyol-initiated ethylene oxide/propylene oxide copolymers having a central branch and an ethylene oxide/propylene oxide weight ratio of from 40:60 to 60:40, starting from an alcohol having at least 4 OH groups, have outstanding properties with regard to pour point, water solubility and viscosity index and at the same time are not toxic on exposure to aerosols. This makes it possible, especially when they are used in the formulation of aqueous metal machining fluids, to avoid complicated technical measures for encapsulating the plants for protection from exposure.

The invention therefore relates to ethylene oxide/propylene oxide copolymers which are obtainable by copolymerization of ethylene oxide and propylene oxide with an alcohol having 4 to 12 carbon atoms and 4 to 12 OH groups, the copolymer having an ethylene oxide/propylene oxide weight ratio of from 40:60 to 60:40 and a molecular weight of from 2000 to 10000 g/mol.

The invention furthermore relates to the use of the copolymers according to the invention for lubricant formulations, formulations for fiber preparation and metal machining fluids, preferably in open systems. Here, open systems are understood as meaning apparatuses in which lubricant formulations, formulations for fiber preparation and metal machining fluids are used and in which aerosols form which may pass from these apparatuses to the outside.

The invention furthermore relates to lubricant formulations, formulations for fiber preparation and metal machining fluids which contain the copolymers according to the invention.

The use of glycols in lubricants and glycol-containing lubricant formulations are described in W. J. Barz, Tribologie und Schmierungstechnik [Tribology and Lubrication Technology], Part 5 (1987), pages 262 to 269. The use of glycols in fiber preparation compositions and glycol-containing fiber preparation compositions are described in P. Ehrler, Textilveredelung [Textile Finishing], Part 16 (1981), pages 403 to 414 and in R. S. Jinkins, K. K. Leonas, 1994 Student Paper Competition, Part 12 (1994), pages 25 to 29. The use of glycols in metal machining fluids and glycol-containing metal machining fluids are described in W. L. Brown, Lubrication Engineering, 1988, pages 168 to 171. The disclosure of these documents is hereby incorporated.

Preferred copolymers according to the invention have a viscosity at 50° C. of from 50 to 1000 mm²/s, determined according to DIN 51562. A viscosity index greater than 200 to 350, determined according to ASTM D2270-74, is likewise preferred. In a further preferred embodiment, the copolymers have a pour point, determined according to ISO 3016, of less than −30° C. An OH number of from 20 to 100 mg KOH/g is preferred. It is an advantage of the invention that, owing to the use of an alcohol having more than 4 hydroxyl groups as a polymerization initiator, the OH number required for a specific viscosity is substantially lower than in the case of linear copolymers of ethylene oxide and propylene oxide.

Depending on the polyhydric alcohol, the ratio of ethylene oxide to propylene oxide is preferably chosen so that the copolymers according to the invention have a turbidity point of from 40 to 60° C. in the form of a 1% strength solution in water.

The copolymers according to the invention are prepared by reacting ethylene oxide and propylene oxide with a polyhydric alcohol. The alcohols correspond to the formula

R—(OH)_{y}

in which R=C₄-C₁₂-alkyl, which may also be branched, and y=4 to 12. In the reaction of ethylene oxide and propylene oxide with the polyhydric alcohol, one or more of the OH groups may react.

Preferred alcohols for the preparation of the copolymers according to the invention are pentaerythritol, sorbitol, dipentaerythritol, diglycerol, triglycerol and ditrimethylolpropane.

For this purpose, the corresponding polyhydric alcohols are melted by heating in a pressure-resistant reactor or dissolved in an inert solvent and, after the addition of the catalyst for forming the corresponding alcoholates (usually potassium hydroxide or potassium methylate), are reacted under pressure with a mixture of ethylene oxide and propylene oxide in the desired molar ratio while stirring in an anionic polymerization. The resulting polymer is neutralized by adding acid. The desired viscosity is determined by means of the resulting molecular weight and is obtained from the ratio of polyhydric alcohol to ethylene oxide/propylene oxide mixture.

Typical formulations for lubricants contain, in addition to polyalkylene glycol as the main component (content>94%), also antiwear additives, EP (extreme pressure) additives, antioxidants, corrosion inhibitors and antifoams (cf. for example EP-A-0 402 009).

The copolymers according to the invention have a very low aerosol toxicity, determined according to D. B. Warheit, Inhalation Toxicol. (1995), 7 (3) 377-92, of in general more than 1000, in particular more than 2000, especially more than 3000, mg/m³. They are therefore particularly suitable for use in those processes in which copolymers occur in the form of a fine dust. The invention is to be explained in more detail with reference to a few examples.

### EXAMPLE 1

Pentaerythritol-initiated Ethylene Oxide/Propylene Oxide Copolymer, MW 4000 g/mol

0.1 mol of pentaerythritol is reacted with 0.3 mol of sodium methanolate in an inert solvent (monoglyme) in a laboratory autoclave to give the alcoholate. Methanol is distilled off under reduced pressure. Thereafter, a mixture of 4 mol of ethylene oxide and 4 mol of propylene oxide is added and polymerization is carried out for 10 hours at about 140° C. under pressure. The resulting polymer is neutralized with isononanoic acid. The monoglyme is evaporated under reduced pressure. The hydroxyl number is determined by reacting the polymer with an excess of acetic anhydride and titrating the excess acetic anhydride, which has not reacted with the polymer OH groups, with potassium hydroxide solution. The hydroxyl number is 56 mg KOH/g. According to the hydroxyl number, the polymer has a molecular weight of 4000 g/mol. The kinematic viscosity, determined by the method according to DIN 51562, is 300 mm²/s at 50° C., the viscosity index, determined by the method according to ASTM D 2270-74, is 243 and the pour point, determined by the method according to ISO 3016 is −37° C. The turbidity point of the 1% strength solution in water, i.e. the temperature at which the aqueous solution is no longer clear, is 48° C.

In the investigation of the aerosol toxicity, as described in D. B. Warheit, Inhalation Toxicol. (1995), 7 (3) 377-92, on rats, the copolymer has an LC₅₀ value greater than 5100 mg/m³. The copolymer is thus outstandingly suitable for the formulation of lubricants and metal machining fluids which are used in open systems.

### EXAMPLE 2

Pentaerythritol-initiated Ethylene Oxide/Propylene Oxide Copolymer, MW 7500 g/mol

0.1 mol of pentaerythritol is reacted with 0.3 mol of sodium methanolate in an inert solvent (monoglyme) in a laboratory autoclave to give the alcoholate. Methanol is distilled off under reduced pressure. Thereafter, a mixture of 8 mol of ethylene oxide and 7 mol of propylene oxide is added and polymerization is carried out for 10 hours at about 140° C. under pressure. The resulting polymer is neutralized with lactic acid. The monoglyme is distilled off under reduced pressure. The characteristics are determined as described in Example 1. The hydroxyl number is 30 mg KOH/g. According to the hydroxyl number, it has a molecular weight of 7500 g/mol. The viscosity is 720 mm²/s at 50° C., the viscosity index is 280, the pour point is −31° C. and the turbidity point as a 1% strength solution in water is 55° C.

In the investigation of the aerosol toxicity on rats, as described in Example 1, the copolymer has an LC₅₀ value greater than 5000 mg/m³. The copolymer is thus outstandingly suitable for the formulation of lubricants and metal machining fluids which are used in open systems.

### EXAMPLE 3

Gear Lubricant Based on the Polyglycol from Example 2

0.5% by weight of monoisotridecyl phosphate, 0.05% by weight of benzotriazole, 0.5% by weight of butylhydroxyanisole, 0.5% by weight of 4,4′-methylenebis-2,6-ditert-butylphenol and 2% by weight of phenyl-alpha-naphthylamine are stirred into 96.45% by weight of the polyglycol from Example 2 at 80° C. The resulting oil is outstanding for use as a high-viscosity gear oil.

### EXAMPLE 4

Fiber Lubricant Based on the Polyglycol from Example 2

5% by weight of Genapol LA 070 (fatty alcohol ethoxylate) and 0.5% by weight of butylhydroxyanisole and 1.5% by weight of lauryidimethylamine oxide are stirred into 93% by weight of the polyglycol from Example 2 at 80° C. The resulting oil is outstandingly suitable as an excellent lubricant in fiber production, without further additives.

### COMPARATIVE EXAMPLE

Methanol-initiated Ethylene Oxide/Propylene Oxide Copolymer

0.1 mol of sodium methanolate dissolved in methanol is reacted in a laboratory autoclave to give the alcoholate. Methanol is distilled off under reduced pressure. Thereafter, a mixture of 15 mol of ethylene oxide and 15 mol of propylene oxide is added and polymerization is carried out for 10 hours at about 140° C. under pressure. The resulting polymer is neutralized with lactic acid. The characteristics are determined as described in Example 1. The hydroxyl number is 11 mg KOH/g. According to the hydroxyl number, it has a molecular weight of about 5000 g/mol. The viscosity is 690 mm²/s at 50° C., the viscosity index is 280, the pour point is −35° C. and the turbidity point as a 1% strength solution in water is 49° C.

However, on investigation of the aerosol toxicity on rats, the copolymer has an LC₅₀ value of 390 mg/m³. The linear copolymer is therefore to be regarded as toxic on inhalation and is not suitable for formulating lubricants and metal machining fluids which are used in open systems.

1. An ethylene oxide/propylene oxide copolymer which is obtainable by copolymerizing ethylene oxide and propylene oxide with an initator alcohol having 4 to 12 carbon atoms and 4 to 12 OH groups, the copolymer having an ethylene oxide/propylene oxide weight ratio of from 40:60 to 60:40 and a molecular weight of from 2000 to 10000 g/mol.

2. The copolymer as claimed in claim 1, wherein its viscosity is from 50 to 1000 mm²/s at 50° C.

3. The copolymer as claimed in claim 1, which has a pour point of less than −30° C.

4. The copolymer as claimed in claim 1, wherein its turbidity point in water as a 1% strength solution is from 40 to 60° C.

5. The copolymer as claimed in claim 1, wherein the alcohol initiator used is pentaerythritol, sorbitol, dipentaerythritol, diglycerol, triglycerol or ditrimethylolpropane.

6. The copolymer as claimed in claim 1, which has a viscosity index of more than 200.

7. The copolymer as claimed in one or more of claims 1 to 6, wherein its hydroxyl number is from 20 to 100 mg KOH/g.

8. A method of preparing a lubricant formulation comprising the steps of:
providing a lubricant formulation; and
adding a copolymer as claimed in claim 1 to said lubricant formulation.

9. A lubricant formulation, formulation for fiber preparation or metal machining fluid containing a copolymer as claimed in claim 1.
